(19) United States
(12) Patent Application Publication
(10) Pub. No.: US 2016/0096466 A1
(43) Pub. Date: Apr. 7, 2016

(54) LIGHT CONTROL DEVICE

(71) Applicant: DENSO CORPORATION, Kariya-City, Aichi-pref. (JP)

(72) Inventors: Kazuhisa Okumura, Kariya-shi, Aichi-ken (JP); Ryu Mizuno, Kariya-shi, Aichi-ken (JP)

(21) Appl. No.: 14/892,522

(22) PCT Filed: May 12, 2014
(86) PCT No.: PCT/JP2014/062621

§ 371 Date: Nov. 19, 2015

(30) Foreign Application Priority Data
May 20, 2013 (JP) 2013-106209

(51) Int. Cl. B60Q 1/08; B60Q 1/14

(52) U.S. Cl. CPC B60Q 1/085; B60Q 1/143; B60Q 2300/20

(57) ABSTRACT

Provided is a novel control technology for a light device for a vehicle. The control device starts an alighting illumination process after a vehicle stops so as to ensure the driver's field of view when alighting the vehicle. When the alighting illumination process is started, the control device stands by until the driver alights the vehicle (S110). When the driver alights the vehicle, it is determined whether the vehicle is in the premises of the driver's home, and whether it is nighttime (S120, S130). If the determinations are both affirmative (Yes in S130), a lighting control process is started (S140). In the lighting control process, an area forward of the driver as he or she advances is illuminated with a head lamp while the range of irradiation of light by the head lamp is switched in accordance with the movement of the driver, until the driver enters the home or continuously stays out of the field of view of an external camera.

### TECHNICAL FIELD

The present invention relates to a light control device for a vehicle.

### BACKGROUND ART

Conventionally, devices controlling irradiation directions of lights from headlight devices according to turning of vehicles, devices controlling headlight devices to light for notifying users of positions of vehicles such that the users can efficiently find the vehicles, and the like are known as light control devices for vehicles (see PTL1). As the light control devices of the latter, further, devices switching lamps to light depending on approaching directions of the users are known.

### CITATION LIST

### Patent Literature

[PTL 1] JP-A-2006-48091

### SUMMARY OF INVENTION

### Technical Problem

Apart from the objective of securing the driver's view when the vehicle is traveling, headlight devices are only used for the objective of notification/alert by light. The present invention has an objective of providing a novel control technique of lamps as a technique which can utilize lamps mounted on vehicles such as headlight devices.

### Solution to Problem

A light control device of this disclosure is a light control device controlling a lamp mounted on a vehicle, and has a position detecting means and a controlling means. The position detecting means detects a current position of a user after the user gets out of the vehicle. The controlling means controls the light from the lamp on the basis of the current position of the user detected by the position detecting means.

Thereby, the forward direction of movement of the user is lit by the lamp according to the movement of the user who has got out of the vehicle.

According to the light control system of this disclosure, the lamp mounted on the vehicle can be used for securing the view of the driver when the driver gets out of the vehicle. Therefore, according to this disclosure, the lamp can be utilized conveniently.

A window detecting means for detecting a window of a building in the lighting direction of the lamp can be provided to the light control device of this disclosure. The controlling means can be configured to control the light such that an area of the window which is detected by the window detecting means is not lit. As another aspect, the controlling means can be configured to control the light such that the irradiation amount of the light to the area of the window is reduced relative to that of the outside area thereof.

This control of the irradiation light can prevent the light from the lamp from being transmitted through the window into the building and from dazzling the person in the building. The surrounding environment-conscious lighting can be realized by using the lamp mounted on the vehicle.

Apart from this, the controlling means can be configured to control the light such that an area of an eye of the user is not lit. As another aspect, the controlling means can be configured to control the light such that the irradiation amount of the light to the area of eye of the user is reduced relative to that of the outside area thereof.

This control of the irradiation light can prevent the driver from being dazzled when the forward direction of movement of the driver is lit, and the forward direction of movement can be lit comfortably for the driver.

A headlight device as the lamp mounted on the vehicle can be used for lighting. That is, the controlling means can be configured to control the light of the headlight device mounted on the vehicle as the lamp, thereby lighting the forward direction of movement of the user by the headlight device. According to the light control device, the headlight device mounted on the vehicle can be used effectively, and the forward direction of movement can be lit conveniently for the user.

### BRIEF DESCRIPTION OF DRAWINGS

FIG. 1 is a block diagram showing a configuration of a light control system;

FIG. 2 is a diagram showing an example of lighting from a headlamp;

FIG. 3 is a plan view showing a structure of a headlamp;

FIG. 4 is a flow chart showing a light control process, for getting out of a vehicle, which is executed by a controller;

FIG. 5 is a (first) flow chart showing a light control process which is executed by the controller;

FIG. 6 is a (second) flow chart showing the light control process which is executed by the controller;

FIG. 7 is a diagram showing a formation example of an on/off irradiation pattern of light-emitting diodes; and

FIG. 8 is an explanatory diagram showing an example where lighting is performed with a window and a head of a driver out of a lighting range.

### DESCRIPTION OF EMBODIMENTS

With reference to the drawings, an embodiment of the present invention will now be described.

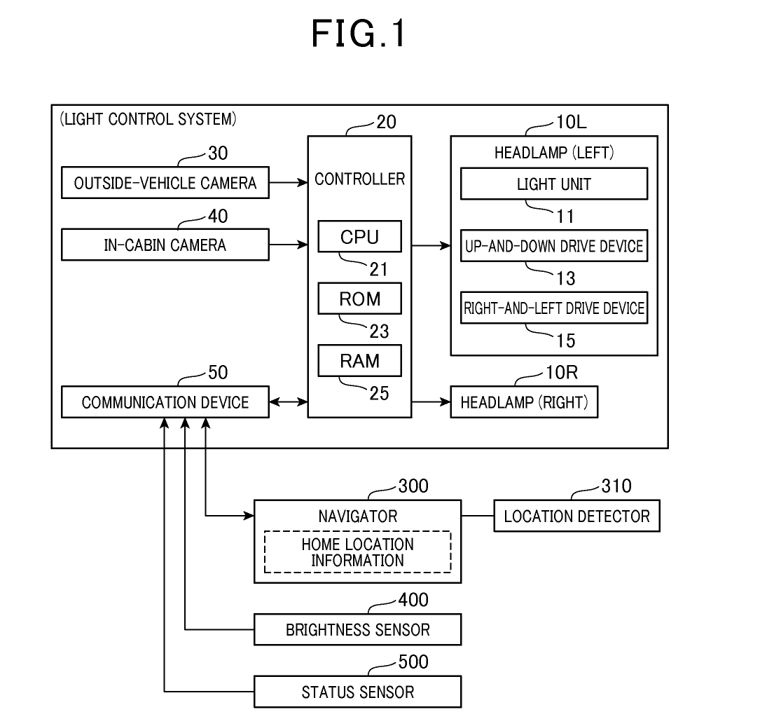

A light control system of this embodiment shown in FIG. 1 has left and right headlamps 10 as a headlight device, a controller 20, an outside-vehicle camera 30, an in-cabin camera 40, and a communication device 50.

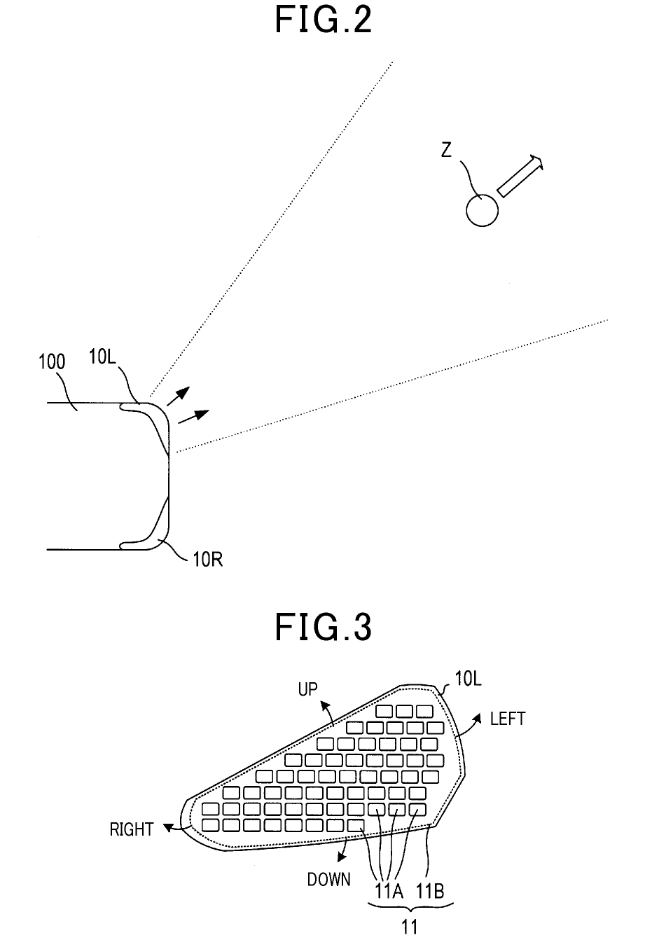

A respective headlamp 10 is provided at each of the right and left sides in the front portion of the vehicle, and used for securing the field of view of the driver Z when the vehicle 100 travels. In FIGS. 1 and 2, the suffix L is added to the headlamp 10 provided on the left side of the vehicle 100, thereby describing it as 10L. The suffix R is added to the headlamp 10 provided on the right side of the vehicle 100, thereby describing it as 10R. In this specification, when the left and right headlamps 10L and 10R are not discriminated, each of these headlamps 10L and 10R is expressed as only headlamp 10.

Each of the left and right headlamps 10 has the same configuration except for having a bilaterally symmetric and geometrical shape. Each headlamp 10 has a light unit 11, an up-and-down drive device 13 and a right-and-left drive device 15, and is controlled by the controller 20 to irradiate light from the light unit 11, thereby lighting the area ahead of the vehicle 100.

Further, each of the headlamps 10, as shown in FIG. 2, is used for lighting the forward track of the driver Z when the driver Z has got out of the vehicle, thereby securing the view of the driver Z when getting out of the vehicle.

The up-and-down drive device 13, as shown in FIG. 3, is configured to change the direction of the light unit 11 in altitude direction (i.e. up and down direction). The up-and-down drive device 13 is controlled by the controller 20 to change the direction of the light unit 11 to the direction specified by the controller 20. Thus, the optical axis of the light unit 11 is regulated in the altitude direction.

On the other hand, the right-and-left drive device 15 is configured to change the direction of the light unit 11 in the azimuth direction (i.e. right and left direction). The right-and-left drive device 15 is, as the up-and-down drive device 13, controlled by the controller 20 to change the direction of the light unit 11 to the direction specified by the controller 20. Thus, the optical axis of the light unit 11 is regulated in the azimuth direction.

The light unit 11 has a configuration where many light-emitting diodes 11A are two-dimensionally or three-dimensionally arrayed on a substrate 11B. The light unit 11 is controlled by the controller 20 to set the respective light-emitting diodes 11A on/off. Further, in this embodiment, the light unit 11 is controlled by the controller 20 to regulate emission intensity of the respective light-emitting diodes 11A.

The controller 20 has a CPU 21 (see FIG. 1), a ROM 23 and a RAM 25. The CPU 21 executes processes according to programs to realize control of the emitting light of the headlamp 10. The ROM 23 stores these programs. The RAM 25 is used as a working area when the CPU 21 executes the processes.

The outside-vehicle camera 30 is a wide angle camera which images the surroundings of the vehicle 100 corresponding to the emitting range of the light by the headlamp 10, and is configured to input video signals indicating the captured images to the controller 20. The outside-vehicle camera 30 may be a monocular camera or a binocular camera. The outside-vehicle camera 30 may be an aggregate of cameras. Further, the outside-vehicle 30 is configured to capture the outside of the vehicle from a very close point to the vehicle 100. That is, the outside-vehicle camera 30 is configured to image the driver Z who has got out of the vehicle from just after getting out of the vehicle.

The in-cabin camera 40 is a camera capturing the inside images of the cabin, and disposed at a position from which a sequence of movements of the driver Z until they open the driver's door and get out of the vehicle can be imaged. The communication device 50 is a communication interface which can communicate with communication nodes connected to an in-vehicle network. The communication device 50 is controlled by the controller 20 to communicate with the in-vehicle communication nodes and input the received data to the controller 20.

For example, the communication device 50 acquires current location information and home location information of the driver Z from a navigator 300 as the communication node. In addition to this, the communication device 50 acquires information indicating the brightness of the outside of the vehicle from a brightness sensor 400 detecting the brightness of the outside of the vehicle, and acquires information indicating vehicle status from a group of status sensors 500 for detecting other vehicle status. The communication device 50 inputs the information to the controller 20.

The navigator 300, as known, acquires the current location information of the vehicle 100 from a location detector 310 such as typified by a GPS receiver to display the map of the vicinity of the current location or to guide a route to a destination. In this embodiment, the navigator 300 is configured to provide the light control system 1 through the in-vehicle network with the current location information of the vehicle 100 acquired from the location detector 310 and the home location information which is the location information of the specific point registered as home.

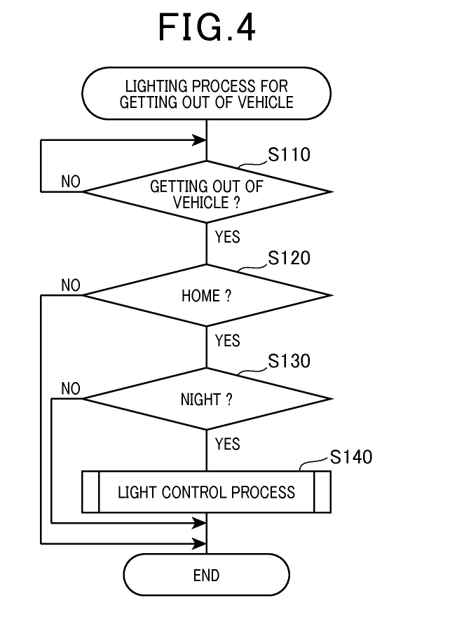

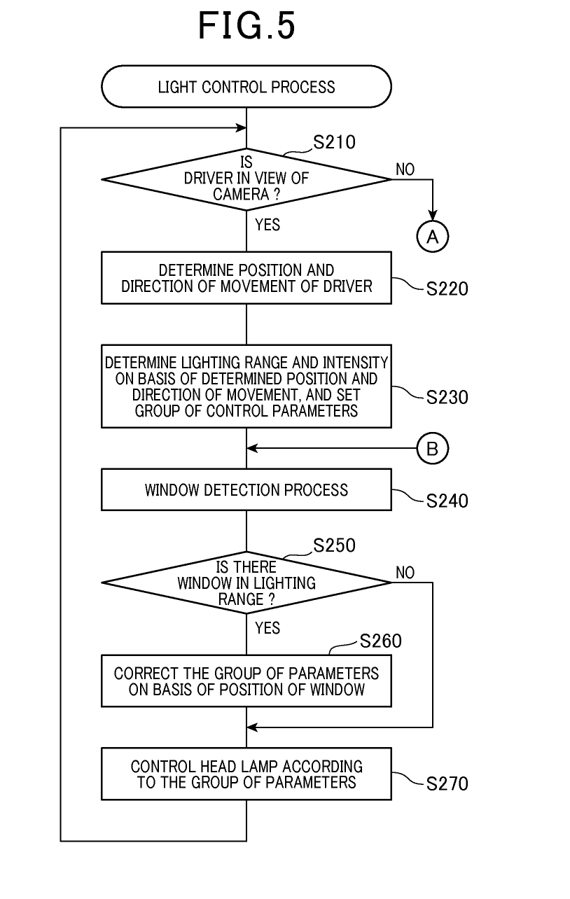

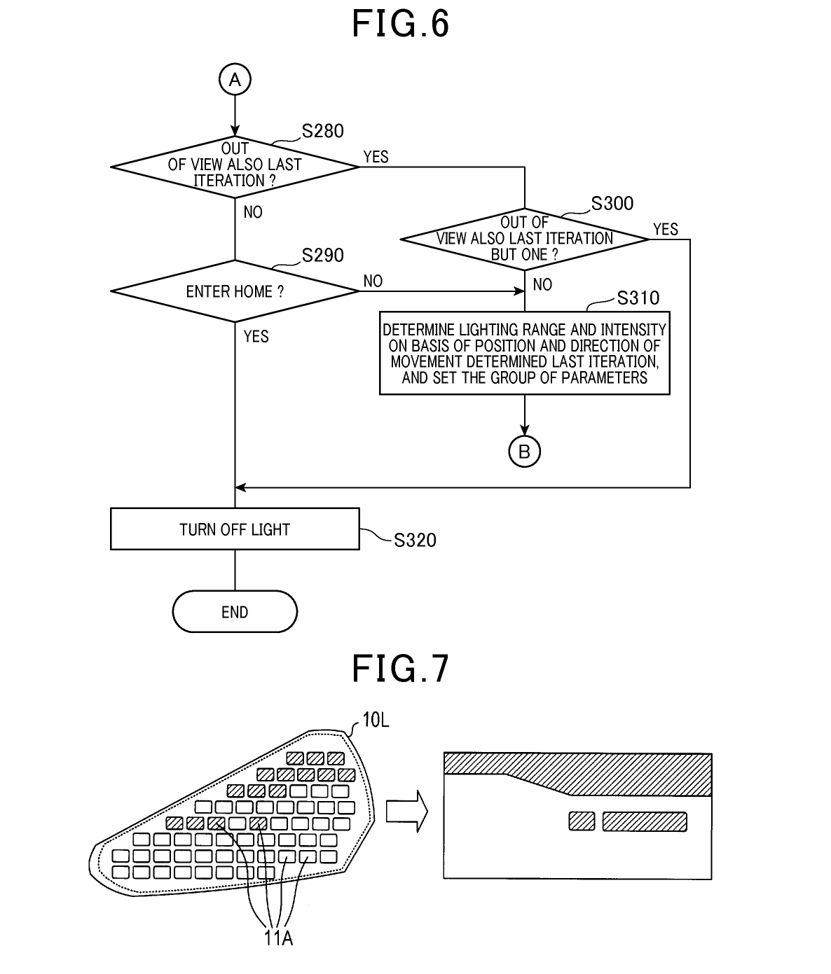

Next is described the processes which the controller 20 executes. The controller 20 initiates a lighting process for getting out of the vehicle in order to secure the view of the driver Z when the driver gets out of the vehicle, after the vehicle 100 stops, as shown in FIG. 4. Hereinafter is described the lighting process for getting out of the vehicle and the light control process shown in FIGS. 5 and 6 by the controller 20. The CPU 21 provided in the controller 20 executes the processes according to the programs stored on the ROM 23, thereby realizing these process.

After starting the lighting process for getting out of the vehicle, the controller 20 waits until the driver Z exits the vehicle 100 (S110). It can be determined whether the driver has got out of the vehicle by analyzing the video signal from the in-cabin camera 40. This determination may be performed on the basis of a door sensor which is one of the status sensors 500, specifically a door sensor detecting opening and closing of the driver's door, in addition to or in place of the video signal from the in-cabin camera 40.

If the driver Z has got out of the vehicle (Yes in S110), the controller 20 proceeds to S120, and determines whether the vehicle 100 is on the premises of the driver Z's home. The controller 20 acquires, for example, the current location information of the vehicle and the home location information from the navigator 300 through the communication device 50, and can perform the determination on the basis of the acquired information.

If the controller determines the vehicle 100 is not on the premises of home (No in S120), the controller terminates the lighting process for getting out of the vehicle. On the other hand, if it is determined that the vehicle 100 is on the premises of home (Yes in S120), the controller proceeds to S130.

In S130, the controller 20 determines it is night or not. For example, information indicating brightness of the outside of the vehicle is acquired from the brightness sensor 400. If the brightness of the outside of the vehicle is below a standard level on the basis of the acquired information, it can be determined that it is night. If the brightness is the standard level or more, it can be determined that it is not night. Alternatively, the controller 20 may determine whether it is night or not by analyzing the video signal from the outside-vehicle camera 30.

If the controller 20 determines it is not night (No in S130), the controller 20 terminates the lighting process for getting out of the vehicle. On the other hand, if it is determined that it is night (Yes in S130), the controller proceeds to S140, and executes the light control process shown in FIGS. 5 and 6. Thereafter, the lighting process for getting out of the vehicle is terminated.

On initiating the light control process in S140, the controller 20 determines whether the driver Z is in view of the outside-vehicle camera 30 (S210). In S210, the controller determines whether the driver Z is in the captured image of the outside-vehicle camera 30 which the video signal from the outside-vehicle camera 30 indicates, thereby it is determined that the driver Z is in view of the outside-vehicle camera 30. It can be determined whether the person in the captured image is the driver Z who has got out of the vehicle or not, for example, by checking the face in the captured image of the outside-vehicle camera 30 with the face of the driver Z which was captured by the in-cabin camera 40 before the driver Z has got out of the vehicle.

If it is determined that the driver Z is in view (Yes in S210), the controller proceeds to S220, and analyzes the video signal of the outside-vehicle camera 30 to determine the position and the direction of movement of the driver Z to the vehicle 100. That is, in S210 and S220, the controller recognizes the face of the driver Z in the captured images of the outside-vehicle camera 30 which the video signal indicates, and determines the position and the direction of movement of the driver Z relative to the vehicle 100 from the position and direction of the driver Z in the captured images.

Thereafter, the controller 20 decides the lighting range of the light by the right and left headlamps 10 on the basis of the determined position and direction of movement of the driver Z. The controller sets a group of control parameters of the headlamps 10 such as to light the decided lighting range selectively (S230).

Specifically, the controller 20 decides the periphery of the driver Z and a predetermined range in the forward direction of movement of the driver Z as the lighting range. However, the lighting range is set such that the head of the driver Z is out of the lighting range. In S230, the controller can decide a respective irradiation intensity of each part of the decided lighting range and can set the group of the control parameters to realize the decided irradiation intensity.

The group of control parameters in this embodiment includes control parameters for controlling the directions (altitude angle and azimuth angle) of the right and left headlamps 10, and control parameters for controlling on/off and light emission intensity (driving current) of each light-emitting diode 11A.

Thereafter, the controller 20 executes a window detection process (S240). In the window detection process, the controller detects a window of a building imaged in the captured images of the outside-vehicle camera 30 on the basis of the video signal from the outside-vehicle camera 30. In S240, for example, since window frames generally have rectangular shapes, a rectangular area in the captured images can be recognized as a window.

Window frames are generally metallic, and have higher reflectance than that of the periphery thereof. Accordingly, the window detection process can be configured to detect a rectangular area which shows high luminance in the captured image as a window. When a window is detected from the captured image, the captured image is transformed into an edge image using differential filter or the like, and the rectangular area in the edge image is detected as a window. Further, in S240, the controller determines the relative position (window position) of the detected window to the vehicle 100.

After finishing the process in S240, the controller 20 determines, on the basis of the detection result in the window detection process, whether the window is in the lighting range decided in S230 or S310 described below (S250). If it is determined that the window is in the lighting range (Yes in S250), the controller corrects the group of control parameters set in S230 or S310 on the basis of the window position detected in the window detection process (S260).

Specifically, the controller corrects the group of control parameters such as to remove the area of the window in the lighting range decided in S230 or S310 from the lighting range. In this embodiment, on/off of each light-emitting diode 11A provided in the light unit 11 is switched respectively, thereby forming a local area where the light is not irradiated.

For example, if a part of the light-emitting diodes 11A provided in the light unit 11 is set off as shown in the left side of FIG. 7, a lighting (light distribution) pattern as shown in the right side of FIG. 7 can be formed. In the left area of FIG. 7, the hatched light-emitting diodes 11A show the light-emitting diodes 11A set off, and the light-emitting diodes 11A which are not hatched show the light-emitting diodes 11A set on. Similarly, the hatched area in the rectangular area shown in the right side of FIG. 7 show the area which are not lit, and the other area show the lit area.

In S260, the group of control parameters is corrected such as to change the light-emitting diodes 11A which are set on and the light-emitting diodes 11A which are set off. Thereby, the group of control parameters can be corrected to remove the area of the window from the lighting range.

On finishing the process of S260 as described above or making negative judgement in S250, the controller 20 proceeds to S270, and controls the headlamps 10 according to the group of control parameters to light the lighting range according to the group of control parameters from the right and left headlamps 10 with the irradiation intensity according to the group of control parameters. In S270, one or both of the right and left headlamps 10 is lit according to the group of control parameters.

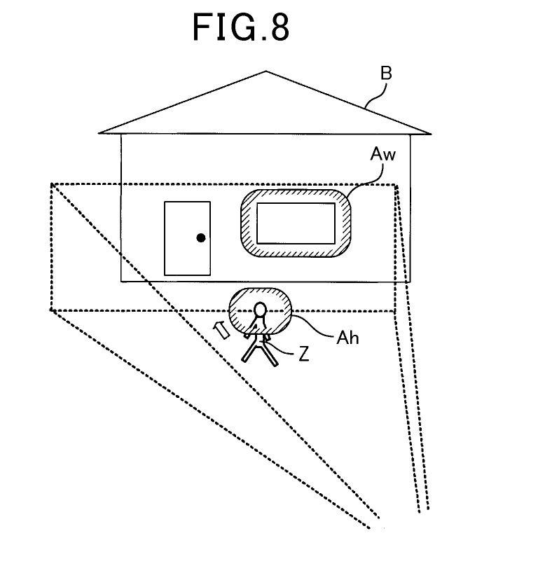

Specifically, after proceeding from S260 to S270, the controller controls the right and left headlamps 10 according to the group of control parameters. Thus, as shown in FIG. 8, the irradiation light from the headlamps 10 is controlled such as not to light the area Aw of the window of the building B and the area Ah of the head of the driver Z (especially the eyes of the driver Z), and the periphery and the forward direction of movement of the driver Z are lit by the headlamps 10. The dashed lines shown in FIG. 8 show the lighting range, and the parts surrounded by partially hatched areas show areas which are in the lighting range shown by the dashed lines and not lit.

On the other hand, when making negative judgement in S250 and proceeding to S270, the controller 20 controls the right and left headlamps 10 according to the group of control parameters set by the process of S230 or S310. Thus, the irradiation light from headlamps 10 is controlled not to light the area of the head of the driver Z, and the periphery and the forward direction of movement of the driver Z are lit by the headlamps 10.

Thus, after finishing the process in S270, the controller 20 proceeds to S210. In addition to this, if the controller 20 determines that the driver Z is not in view of the outside-vehicle camera 30 in S210, the controller executes the processes from S280 onward. Specifically, if determines in the last iteration of S210 that the driver Z is in the view, the controller makes negative judgement in S280 and proceeds to S290.

On proceeding to S290, the controller 20 determines whether the driver Z enters their home on the basis of the video signal acquired from the outside-vehicle camera 30 from a predetermined time before. If determines that the driver Z has entered their home (Yes in S290), the controller turns the right and left headlamps 10 off (S320), and terminates the light control process.

On the other hand, if making negative judgements in S290, the controller proceeds to S310. In addition to this, if the controller determined that the driver Z was not in the view in the last iteration of S210 but the driver Z was in the view in the last iteration of S210 but one, the controller makes a positive judgement in S280, makes a negative judgement in the following S300, and proceeds to S310.

In S310, the controller decides the lighting range by the right and left headlamps 10 on the basis of the current position and the direction of movement of the driver Z determined in S220 at last iteration. The controller sets the group of parameters such as to light the lighting range selectively. Thereafter, the controller proceeds to S240, and executes the processes following thereof.

Apart from this, if the controller determined that the driver Z was not in the view in the last iteration of S210 and the last iteration of S210 by one, the controller makes positive judgments in S280 and S300, proceeds to S320, turns the right and left headlamps 10 off, and thereafter terminates the light control process.

Thus, in the light control process of this embodiment, the controller changes the lighting range of the headlamps 10 according to the movement of the driver Z to light the forward direction of movement of the driver Z by the headlamps 10. The light control process is executed after the driver Z gets out of the vehicle until the driver Z enters home or the state where the driver is out of view continues.

The light control system 1 of this embodiment is described above. According to the light control system of this embodiment, the headlamps 10 mounted on the vehicle 100 can be used for securing the view of the driver Z when the driver gets out of the vehicle, and the headlamps 10 can be utilized conveniently.

Especially, according to this embodiment, when the headlamp 10 lights the forward direction of movement of the driver Z, windows provided in the periphery buildings are detected, and the areas of the windows are removed from the lighting range. Accordingly, this embodiment can prevent the light from the headlamp 10 from being transmitted through the window into the building and from dazzling the person in the building. That is, according to this embodiment, the surrounding environment-conscious lighting can be realized by using the headlamps 10 mounted on the vehicle 100.

In addition to this, the area of the head of the driver Z is removed from the lighting range. Accordingly, this embodiment can prevent the driver Z from being dazzled when the forward direction of movement of the driver Z is lit, and the forward direction of movement can be lit comfortably for the driver Z.

Further, in this embodiment, when the driver Z is out of view of the outside-vehicle camera 30 or the driver Z enters their home, the headlamp 10 is turned off. Accordingly, there is no need for actively operating the light control system 1 by the driver Z in order to turn the light of the headlamp 10 off, therefore the lighting function of the headlamp 10 can be used conveniently.

### Other Modifications

The present invention is not limited to the above-described embodiment, and various aspects can be adopted.

For example, in the above embodiment, the area of the window is removed. However, in S260 of the light control process, the group of control parameters may be corrected such that the irradiation amount (intensity) of the light to the area of the window in the lighting range is reduced relative to that of the outside area thereof. The correction of the group of control parameters can prevent the light from the headlamp 10 from being transmitted through the window into the building and from dazzling the person in the building, even if the irradiation light from the headlamp 10 is controlled.

Similarly, in the above embodiment, the area of the head of the driver Z is removed from the lighting range. However, in S230 of the light control process, the group of control parameters may be corrected such that the irradiation amount (intensity) of the light to the area of the head of the driver Z in the lighting range is reduced relative to that of the outside area thereof. The setting of the group of control parameters can also prevent the driver Z from being dazzled.

Apart from this, the headlamp 10 is not limited to the configuration having a plurality of light-emitting diodes 11A. That is, the present invention can be applied to vehicles having other headlamps. For example, the present invention can also be applied to vehicles having headlamps where projector lamps are configured to be driven upward, downward, leftward and rightward. Further, the light control system 1 is not limited to the headlamp 10, and can control various type of lights mounted on the vehicle 100 to light the forward direction of movement of the user.

### Correspondence

The correspondences between the terms are as follows. The function realized by S210 and S220 executed by the controller 20 corresponds to an example of the function realized by the position detecting means. The function realized by S230, S250 to S270, S310 and S320 corresponds to an example of the function realized by the controller, and the function realized by S240 corresponds to an example of the function realized by the window detecting means. Apart from this, the function realized by S120 corresponds to an example of the function realized by the determining means, and the function realized by S280, S290 and S300 corresponds to an example of the function realized by the event detecting means.

### REFERENCE SIGNS LIST

1 . . . Light control system, 10 . . . Headlamp, 11 . . . Light unit, 11A . . . Light-emitting diode, 11B . . . Substrate, 13 . . . Up-and-down drive device, 15 . . . Right-and-left drive device, 20 . . . Controller, 21 . . . CPU, 23 . . . ROM, 25 . . . RAM, 30 . . . Outside-vehicle camera, 40 . . . In-cabin camera, 50 . . . Communication device, 100 . . . Vehicle, 300 . . . Navigator, 310 . . . Location detector, 400 . . . Brightness sensor, 500 . . . Status sensor, Z . . . Driver.

1. A light control device controlling a lamp mounted on a vehicle, comprising:
a position detecting means for detecting a current position of a user after the user gets out of the vehicle; and
a controlling means for controlling the light from the lamp on the basis of the current position of the user detected by the position detecting means to light, using the lamp, a forward direction of movement of the user according to the movement of the user who has got out of the vehicle.

2. The light control device according to claim 1, comprising a window detecting means for detecting a window of a building in the lighting direction of the lamp,
wherein
the controlling means controls the light such that an area of the window which is detected by the window detecting means is not lit or such that the irradiation amount of the light to the area of the window is reduced relative to that of the outside area thereof.

3. The light control device according to claim 1 or 2, wherein
the controlling means controls the light such that an area of an eye of the user is not lit or such that the irradiation amount of the light to the area of eye of the user is reduced relative to that of the outside area thereof.

4. The light control device according to claim 1, comprising a determining means for determining whether the vehicle is parked at a specified place,
wherein
the controlling means controls the light to light the forward direction of movement of the user by the lamp if it is determined that the vehicle is parked at the specified place.

5. The light control device according to claim 1, wherein
the position detecting means recognizes, on the basis of images captured by an imaging device imaging the outside of the vehicle, the user in the captured images to detect the current position of the user.

6. The light control device according to claim 5, comprising an event detecting means for detecting at least one of a first event and a second event, the first event being that the user disappears from the captured images, the second event being that the user enters a building,
wherein
the controlling means controls the lamp to turn the lamp off, if at least one of the first and second events has been detected by the event detecting means.

7. The light control device according to claim 1, wherein the controlling means controls the light from a headlight device mounted on the vehicle as the lamp to light the forward direction of movement of the user by the headlight device.
